(19) United States
(12) Patent Application Publication
(10) Pub. No.: US 2020/0335060 A1
(43) Pub. Date: Oct. 22, 2020

(54) DISPLAY PANEL AND DISPLAY DEVICE

(71) Applicant: Wuhan China Star Optoelectronics Technology Co., Ltd., Wuhan (CN)

(72) Inventor: Shidi XIAO, Wuhan (CN)

(73) Assignee: Wuhan China Star Optoelectronics Technology Co., Ltd., Wuhan (CN)

(21) Appl. No.: 16/754,191

(22) PCT Filed: Aug. 5, 2019
(86) PCT No.: PCT/CN2019/099247

§ 371 Date: Apr. 7, 2020

(30) Foreign Application Priority Data
Dec. 19, 2018 (CN) 201811634721.2

(51) Int. Cl. G09G 5/10; G09G 3/20

(52) U.S. Cl. CPC G09G 5/10; G09G 3/20; G09G 2300/0426; G09G 2320/0626; G09G 2310/0224

(57) ABSTRACT

A display panel and a display device are provided, wherein the display panel includes a first substrate, at least one reflective structure, signal traces, and a control circuit. The at least one reflective structure is disposed on the first substrate. The at least one reflective structure includes a reflective layer and an electrochromic layer disposed on the reflective layer. The signal traces are disposed on the first substrate. An orthogonal projection of the at least one reflective structure on the first substrate overlaps at least part of an orthogonal projection of the signal traces on the first substrate. The control circuit is disposed on the first substrate. The control circuit is connected to the electrochromic layer. The present disclosure improves utilization of the backlight and improves display performance.

### FIELD OF INVENTION

The present disclosure relates to the field of display technologies, and in particular, to a display panel and a display device.

### BACKGROUND OF INVENTION

Currently, liquid crystal display (LCD) panels are widely used in various sizes of electronic products. Users also have a higher pursuit of display products. Contrast is an important display parameter of LCD panels, which characterizes the difference between the brightest and the darkest states of panels. The greater the difference range is, the higher the contrast; and the less the difference range is, the lower the contrast. A high contrast ratio makes display effect of panels more rich, vivid, and eye-catching. Therefore, in an optical design of panels, adjustment of contrast is particularly important.

In panel design widely used today, in order to prevent occurrence of display defects such as light leakage, a shielding structure (black matrix, BM) is used as a blocking method, so that about 30% to 70% of a backlight is blocked to different degrees, which makes display image unable to achieve desired display effect, and it is difficult to adjust contrast of display panel to improve display effect.

Technical problem

In panel design widely used today, in order to prevent occurrence of display defects such as light leakage, a shielding structure (black matrix, BM) is used as a blocking method, so that about 30% to 70% of a backlight is blocked to different degrees, which makes display image unable to achieve desired display effect, and it is difficult to adjust contrast of display panel to improve display effect.

### SUMMARY OF INVENTION

### Technical solution

It is an object of the present disclosure to provide a display panel and a display device that adjust contrast and improve display effects.

The present disclosure discloses a display panel including a first substrate, at least one reflective structure, signal traces, and a control circuit. The at least one reflective structure is disposed on the first substrate.

The at least one reflective structure includes a reflective layer and an electrochromic layer disposed on the reflective layer. The signal traces are disposed on the first substrate. An orthogonal projection of the at least one reflective structure on the first substrate overlaps at least part of an orthogonal projection of the signal traces on the first substrate. The control circuit is disposed on the first substrate. The control circuit is connected to the electrochromic layer.

In an embodiment of the present disclosure, the signal traces include a plurality of scan lines and a plurality of data lines interlaced with each other, and a width of the at least one reflective structure is greater than or equal to a width of the data line or the scan line.

In an embodiment of the present disclosure, the display panel further including a second substrate disposed opposite to the first substrate, wherein the second substrate includes a black matrix, and a width of the at least one reflective structure is less than or equal to a width of the black matrix.

In an embodiment of the present disclosure, the first substrate includes an upper surface and a lower surface opposite to the upper surface, the at least one reflective structure is disposed on the upper surface of the first substrate, and the upper surface is away from a backlight.

In an embodiment of the present disclosure, the first substrate includes an upper surface and a lower surface opposite to the upper surface, the at least one reflective structure is disposed on the lower surface of the first substrate, and the lower surface is configured to face a backlight.

In an embodiment of the present disclosure, the display panel further including a driving chip, wherein the control circuit is integrated within the driving chip.

In an embodiment of the present disclosure, the display panel further including a flexible circuit board and an external driving module, wherein the control circuit is connected to the external driving module, and the flexible circuit board is connected to the first substrate.

In an embodiment of the present disclosure, the electrochromic layer is configured to have different transmittance according to different voltages applied on the electrochromic layer by the control circuit.

In an embodiment of the present disclosure, the reflective layer is configured to have different reflectivity according to different voltages applied on the reflective layer by the control circuit.

The present disclosure further provides a display device, which includes the above-mentioned display panel and a backlight disposed under the display panel.

### Beneficial Effect

The present disclosure utilizes an electrochromic layer that reversibly converts between a transparent state and a dark state as a function of voltage to change transmittance of the electrochromic layer, and a reflective layer is used to reflect light passing through the electrochromic layer. After being reflected by the reflective layer, a region in the transparent state is brighter due to reflection again, while a region in the dark state is darker by absorbing a large amount of light, thereby adjusting contrast of display panel, improving utilization of the backlight source, and improving display effect.

### BRIEF DESCRIPTION OF FIGURES

In order to illustrate the technical solutions of the present disclosure or the related art in a clearer manner, the drawings desired for the present disclosure or the related art will be described hereinafter briefly. Obviously, the following drawings merely relate to some embodiments of the present disclosure, and based on these drawings, a person skilled in the art may obtain the other drawings without any creative effort.

FIG. 1 is a schematic cross-sectional view of a display panel according to an embodiment of the present disclosure.

FIG. 2 is a schematic structural view of the display panel according to an embodiment of the present disclosure.

FIG. 3 is a schematic view of a reflective structure according to an embodiment of the present disclosure.

FIG. 4 is a schematic view of a reflective state of the reflective structure according to another embodiment of the present disclosure.

FIG. 5 is a schematic view of an absorption state of the reflective structure according to an embodiment of the present disclosure.

FIG. 6 is a schematic view of an electrochromic layer according to an embodiment of the present disclosure.

FIG. 7 is a schematic view of position of the reflective structure according to an embodiment of the present disclosure.

FIG. 8 is a schematic view of position of the reflective structure according to another embodiment of the present disclosure.

FIG. 9 is a schematic view of connection of the reflective structure according to an embodiment of the present disclosure.

FIG. 10 is a schematic view of the connection of the reflective structure according to another embodiment of the present disclosure.

FIG. 11 is a schematic view of sub-reflective structures according to an embodiment of the present disclosure.

FIG. 12 is a schematic flowchart for a driving method of a display panel according to an embodiment of the present disclosure.

FIG. 13 is a schematic diagram of a display device according to an embodiment of the present disclosure.

The reference numerals are as follows: 100, display panel; 110, display region; 200, first substrate; 210, signal traces; 220, base layer; 221, upper surface; 222, lower surface; 230, scan line; 240, data line; 250, pixel electrode; 260, thin film transistor; 300, second substrate; 310, black matrix; 400, reflective structure; 410, reflective layer; 420, electrochromic layer; 421, first transparent conductive layer; 422, second transparent conductive layer; 423, color-changing material layer; 430, sub-reflective structure; 500, control circuit; 510, driving chip; 520, external driving module; 530, flexible printed circuit; 540, control line; 600, backlight; 700, display device.

### DETAILED DESCRIPTION OF EMBODIMENTS

It will be understood that the terminology, specific structural and functional details disclosed herein are for the purpose of describing representative embodiments, and the application can be embodied in many alternate forms and should not be construed as being limited to the embodiments set forth herein.

The disclosure is further described below with reference to the drawings and alternative embodiments.

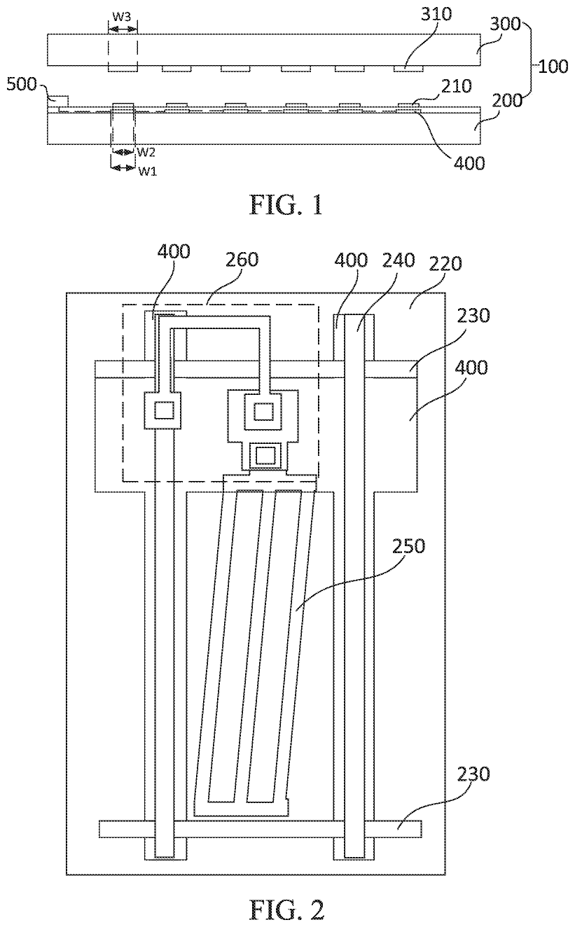

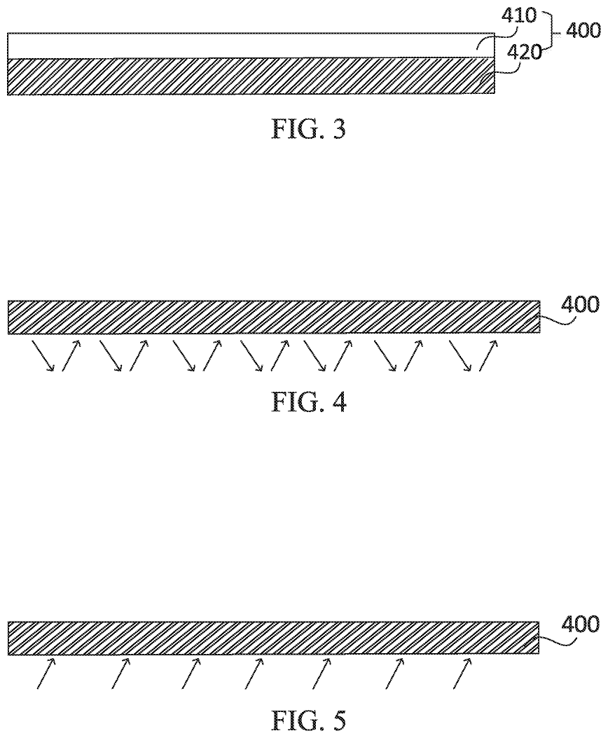

As shown in FIG. 1 to FIG. 3, an embodiment of the present disclosure discloses a display panel 100, including a first substrate 200, at least one reflective structure 400, signal traces 210, a control circuit 500, and a second substrate 300. The first substrate 200 and the second substrate 300 are oppositely disposed. The first substrate 200 is provided with the signal traces 210, the reflective structure 400, and the control circuit 500. The at least one reflective structure 400 includes a reflective layer 410 and an electrochromic layer 420 disposed on the reflective layer 410. The signal traces 210 are disposed on the first substrate 200. An orthogonal projection of the at least one reflective structure 400 on the first substrate 200 overlaps at least part of an orthogonal projection of the signal traces 210 on the first substrate 200. The control circuit 500 is disposed on the first substrate 200. The control circuit 500 is connected to the electrochromic layer 420.

By applying different voltages to the electrochromic layer 420 through the control circuit 500 to control transmittance effect of the electrochromic layer 420, the reflective layer 410 is then activated to make reflectivity of the reflective structure 400 change with voltages. Through adjusting contrast ratio of the display panel 100, the utilization of the backlight source is improved, and display effect is improved.

In an embodiment, the signal traces 210 include a plurality of scan lines 230 and a plurality of data lines 240 interlaced with each other, and a width of the at least one reflective structure 400 is greater than or equal to a width of the data line 240 or a width of the scan line 230. The second substrate 300 includes a black matrix 310, and the width of the at least one reflective structure 400 is less than or equal to a width of the black matrix 310.

In order to reduce reflective phenomenon of a metal layer, generally the data lines 240 in vertical direction are covered by the signal traces 210. The reflective structure 400 is disposed overlapping the signal traces 210, and is positioned under the signal traces 210. If the width of the reflective structure 400 exceeds boundary of the signal traces 210, an aperture ratio is affected. Specifically, the width of the reflective structure 400 is set to be less than a maximum width that can be achieved without affecting the aperture ratio of the panel. The data line 240 charges a pixel electrode 250 through a thin film transistor 260.

More specifically, there are a plurality of reflective structures 400, and all the black matrices 310 in the display region 110 are provided with the reflective structure 400 at corresponding positions. In addition to the scan lines 230 and the data lines 240, there are other metal traces or components on the first substrate 200 that are opaque, and the corresponding positions can be provided with the reflective structure 400 to enhance the dimming effect without affecting the aperture ratio of the panel.

The electrochromic layer can exhibit different color depths at different voltages, thereby changing reflective effect of the reflective structure 400 on the backlight.

As shown in FIG. 4, when the electrochromic layer is in a transparent state, light emitted from the backlight can pass through the electrochromic layer to reach the reflective layer 410, and then is reflected back to the backlight 600 through the reflective layer 410, thereby improving light utilization efficiency and improving brightness of the display panel 100.

As shown in FIG. 5, when the electrochromic layer 420 is dark, light emitted from the backlight is absorbed by the electrochromic layer 420 and cannot reach the reflective layer 410, and brightness of the display panel 100 can be decreased.

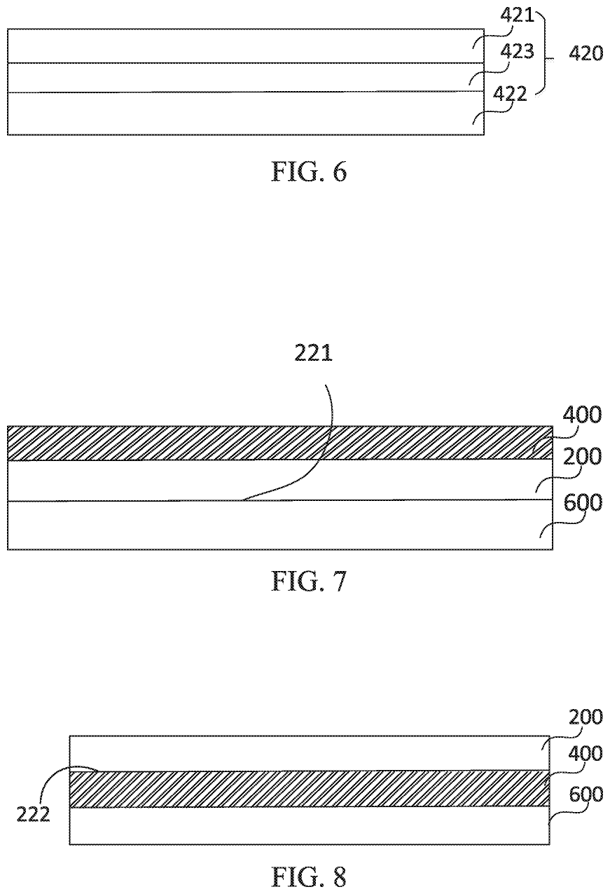

As shown in FIG. 6, the electrochromic layer includes a first transparent conductive layer 421, a second transparent conductive layer 422, and a color-changing material layer 423. The color-changing material layer 423 can be a cathode color-changing material such as tungsten trioxide (WO3) or an anode color-changing material such as nickel oxide (NiO), or other electrochromic materials. The electrochromic layer can be of positive correlation with voltage and can also be of negative correlation with voltage, as long as color transmittance is changed by the voltage on the electrochromic layer and transmittance is further changed.

As shown in FIG. 7, the first substrate 200 includes a base layer 220. The base layer includes an upper surface 221 facing an inside of the display panel 100, and the reflective structure 400 is disposed on the upper surface 221 of the base layer 220. The upper surface 221 under the first substrate 200 is arranged away from the backlight.

In an embodiment of the present disclosure, the first substrate includes an upper surface and a lower surface opposite to the upper surface, and the at least one reflective structure is disposed on the lower surface of the first substrate. The lower surface is arranged to face the backlight.

Each film layer structure of the first substrate 200 is formed on the upper surface 221, and therefore, a process of adding the reflective structure 400 before normal fabrication process of the first substrate 200 does not need to reverse the base layer 220, and is easy to implement. Moreover, the inversion of the base layer 220 is liable to cause breakage, so this embodiment is advantageous for improving the yield. In addition, the reflective structure 400 is formed on same surface of the base layer 220 as the other film layers, thereby ensuring that a lower surface 222 of the base layer 220 can be flat and smooth, and processing errors are less likely to occur, further improving the yield.

As shown in FIG. 8, the first substrate 200 includes the base layer 220. The base layer 220 includes the lower surface 222 that faces the backlight 600, and the reflective structure 400 is disposed on the lower surface 222 of the base layer 220. The lower surface 222 under the first substrate 200 is arranged to face the backlight.

The reflective structure 400 is positioned on a side without film layers of the thin film transistor 260 between the base layer 220 and the backlight. The purpose of different secondary effects of the backlight by the reflective structure 400 under different gray levels is achieved, and due to isolation effect of the base layer 220, an interference on an electric field of the pixel electrodes in the display region caused by an electric field of the reflective structure 400 can be reduced, thereby getting better display effect. Moreover, the reflective structure 400 is positioned outside the display panel 100, and can be additionally processed after the display panel 100 is completed. It can also be flexibly customized according to market demands.

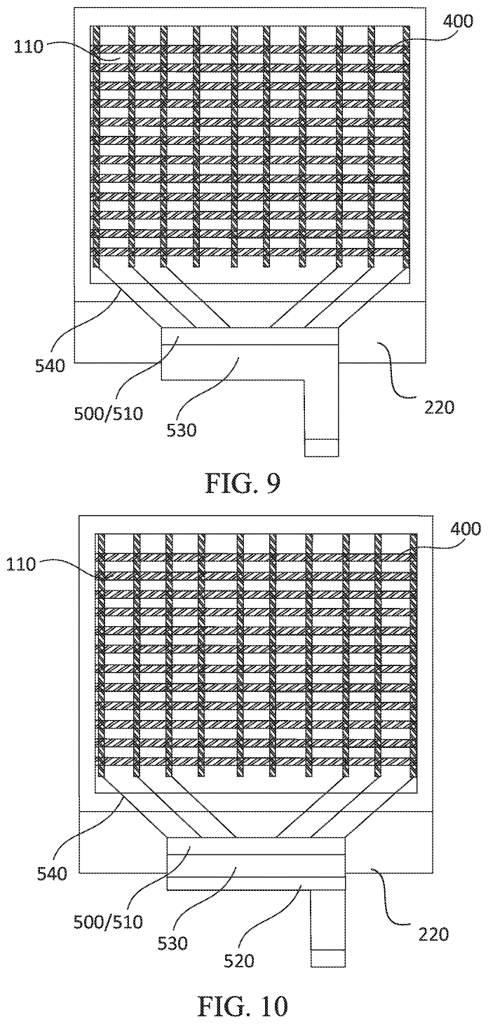

As shown in FIG. 9, the display panel includes a driving chip 510, and the control circuit 500 is integrated in the driving chip 510.

Taking a source driving chip 510 as an example, voltage on the electrochromic layer is controlled by an existing driving chip of the display panel 100. Specifically, the reflective structure 400 is connected to integrated circuit (IC) output pins of the driving chip 510 through connecting lines, and reflective effect of the reflective structure 400 is controlled by the driving chip 510.

The driving chip 510 includes but is not limited to the source driving chip 510, a gate driving chip 510, and a timing control chip. As long as it is the existing driving chip 510 of the display panel 100, the software can be upgraded to control the electrochromic layer.

Of course, the control circuit 500 can also be designed separately, and an external driving module 520 is used to control the electrochromic layer 420.

As shown in FIG. 10, in an embodiment, the control circuit 500 is controlled by an external driving module 520 disposed on a flexible printed circuit (FPC) 530. The flexible printed circuit 530 is connected to the base layer.

The display panel 100 includes the flexible printed circuit 530 and the external driving module 520. The control circuit 500 is connected to the external driving module 520, and the flexible printed circuit 530 is connected to the first substrate 200.

In one embodiment, the electrochromic layer 420 is configured to have different transmittances according to different voltages applied to the electrochromic layer 420 by the control circuit 500. The reflective layer 410 is configured to have different reflectivity according to different voltages applied on the reflective layer 410 by the control circuit 500.

The external driving module 520 does not occupy the original driving circuit of the display panel, so implementation manner is relatively simple, does not affect the original function of the display panel, control method is more flexible, and more control pins are used to drive the electrochromic layer 420. The external driving module 520 is connected to the base layer through the FPC, which saves space of the display panel, and fixing method is also more flexible and can be applied to different models.

More specifically, the external driving module 520 and the source driving chip 510 are disposed on same flexible printed circuit 530. The external driving module 520 and the source driving chip 510 are respectively disposed on opposite surfaces of the flexible printed circuit 530. That is, the external driving module 520 is disposed facing the lower surface 222 of the base layer 220.

Generally, the source driving chip is connected to the base layer through the FPC, so that the external driving module 520 and the source driving chip are combined to save the use of the FPC, and the structure is also more compact, which is advantageous for realizing a narrow frame. This solution is particularly applicable to the case where the reflective structure 400 is disposed on a second side of the base layer 220.

In an embodiment, the reflective structure 400 includes a plurality of sub-reflective structures 430 that are respectively connected to the control circuit 500, each sub-reflective structure 430 being independently controlled.

There are bright and dark regions in different regions of an image, so single contrast ratio setting is not applicable to all images. Single contrast ratio cannot fully express details of the image, and distribution of the light and dark regions of the image may destroyed, resulting in poor adjusting effects. By dividing the region, the plurality of sub-reflective structures 430 are individually controlled. In order to be darker and brighter in the same frame, the contrast of the image is adjusted by the reflective structure 400 based on each of the divided regions, so that the image display performance is better and the contrast adjustment is more scientific.

The sub-reflective structure 430 is divided into a plurality of regions in horizontal and vertical directions in the display region 110. When shape and internal design of the display region 110 are uniform, the sub-reflective structure is uniformly divided into the plurality of regions. When the display region 110 has an irregular shape and an internal design is uniform, the sub-reflective structure is non-uniformly divided into the plurality of regions. The division criterion is to maintain excellent display effect.

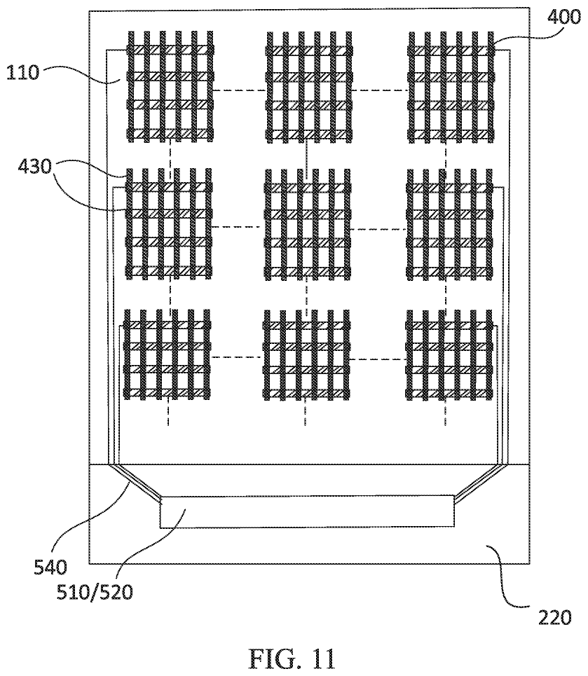

As shown in FIG. 11, the reflective structure 400 is divided into nine sub-reflective structures 430 that are evenly distributed within the display region 110 of the first substrate 200. The control circuit 500 integrated in the driving chip 510 is disposed in a non-display region on a side of the first substrate 200. The control lines 540 are respectively disposed on two sides of the non-display region and respectively connected to the control circuit 500 and the sub-reflection structures 430 on both sides, and the sub-reflective structure 430 at an intermediate position is then connected to the nearest sub-reflective structure 430 by traces in the display region 110.

Of course, the control circuit 500 can also adopt a distributed setting. More specifically, the control circuit 500 includes a plurality of control chips distributed in the non-display region of respective sides of the first substrate 200, and the different sub-reflective structures 430 nearby are individually controlled to simplify the routing mode.

In this embodiment, the voltage of the sub-reflective structure 430 can be controlled by an existing driving chip of the display panel 100, and the voltage on the sub-reflective structure 430 can also be controlled by an external driving module. Of course, if the display panel 100 is very finely divided, control of different sub-reflective structures 430 by divided regions can also be achieved through the external driving module and the source driving chip 510 disposed on the same flexible printed circuit 530 and arranged opposite to each other.

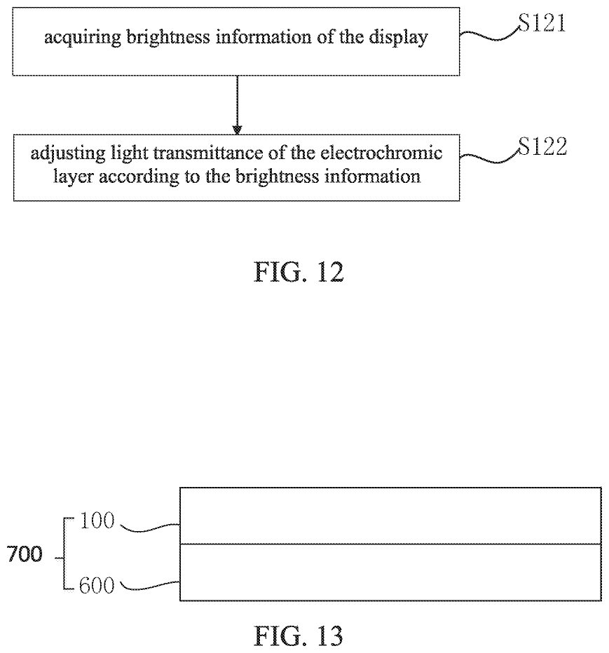

As shown in FIG. 12, an embodiment of the present disclosure further discloses a driving method for a display panel, which is applicable to the display panel of the present disclosure, and specifically includes:

S121, acquiring brightness information of the display panel; and

S122, adjusting light transmittance of the electrochromic layer according to the brightness information.

In one embodiment, a method of adjusting the light transmittance of the electrochromic layer according to the brightness information includes that the light transmittance increases as the brightness information increases, and decreases as the brightness information decreases.

When the brightness information is increased and the panel is in a high gray level state, the reflective structure exhibits a high reflectivity effect, so that secondary utilization effect of the backlight in the black matrix is increased, and utilization ratio of the backlight in the high gray level state is increased, thereby increasing brightness of the panel display.

When the brightness information is decreased and the panel is in a low gray level state, the reflective structure exhibits a high absorption effect, so that originally blocked backlight is mostly absorbed, preventing light leakage, thereby failing to achieve a gain of backlight effect in the low gray level state. The present application allows the backlight to achieve a gain effect in the high gray level, while the backlight of the low gray level cannot obtain the gain effect, thereby improving the panel display effect to improve the contrast ratio.

More specifically, when the brightness information is greater than or equal to a preset first threshold, adjusting a control voltage of the electrochromic layer to maximize the transmittance of the electrochromic layer. When the brightness information is lower than a second threshold, adjusting the control voltage to minimize the transmittance of the electrochromic layer. The relationship between the control voltage and light transmittance depends on specific material and structure of the electrochromic layer, and there is a positive correlation or an inverse correlation, which are not limited herein. The first threshold and the second threshold are also dependent on the specific application scenario. For control simplicity, it is also feasible to equal values of the first threshold and the second threshold.

In order to enhance display effect, light transmittance of the electrochromic layer can be continuously changed following the brightness information. The brightness information can be read from the timing control chip or the source driving chip to derive the brightness information from a current image frame.

Of course, the technical solution of the present disclosure is also applicable to an application for reducing contrast ratio, that is, light transmittance decreases as the brightness information increases, and light transmittance increases as the brightness information decreases.

As shown in FIG. 13, an embodiment of the present disclosure further discloses a display device 700, including any one of the aforementioned display panels 100 and the backlight 600 disposed on the display panel 100. In an embodiment, the first substrate 200, the reflective structure 400, and the backlight 600 are sequentially disposed, that is, the reflective structure 400 is disposed between the first substrate 200 and the backlight 600. In another embodiment, the reflective structure 400, the first substrate 200, and the backlight 600 are sequentially disposed, that is, the first substrate 200 is disposed between the reflective structure 400 and the backlight 600.

It should be noted that the limitation of each step involved in the present solution is not determined to limit sequence of steps without affecting implementation of the specific solution. The described previous steps may be performed first or executed later, or even simultaneously. As long as the solution can be implemented, it should be considered as the scope of protection of the present disclosure.

The technical solution of the present disclosure can be widely applied to various display panels, such as a twisted nematic (TN) display panel, an in-plane switching (IPS) display panel, a vertical alignment (VA) type display panel, and a multi-domain vertical alignment (MVA) display panel. Of course, other types of display panels, such as organic light-emitting diode (OLED) display panels, can also adopt the aforementioned solution.

Embodiments of the present invention have been described, but not intended to impose any unduly constraint to the appended claims. For a person skilled in the art, any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. A display panel, comprising:
a first substrate;
at least one reflective structure disposed on the first substrate, wherein the reflective structure comprises a reflective layer and an electrochromic layer disposed on the reflective layer, the electrochromic layer configured to have different transmittance according to different voltages applied on the electrochromic layer by a control circuit, and the reflective layer configured to have different reflectivity according to different voltages applied on the reflective layer by the control circuit, wherein the control circuit is disposed on the first substrate and is connected to the electrochromic layer;
signal traces disposed on the first substrate, wherein an orthogonal projection of the at least one reflective structure on the first substrate overlaps at least part of an orthogonal projection of the signal traces on the first substrate, the signal traces comprise a plurality of scan lines and a plurality of data lines interlaced with each other, and a width of the at least one reflective structure is greater than or equal to a width of the data line or the scan line; and
a second substrate, comprising a black matrix, wherein the width of the at least one reflective structure is less than or equal to a width of the black matrix.

2. A display panel, comprising:
a first substrate;
at least one reflective structure disposed on the first substrate, wherein the reflective structure comprises a reflective layer and an electrochromic layer disposed on the reflective layer;
signal traces disposed on the first substrate, wherein an orthogonal projection of the at least one reflective structure on the first substrate overlaps at least part of an orthogonal projection of the signal traces on the first substrate; and
a control circuit disposed on the first substrate, and connected to the electrochromic layer.

3. The display panel of claim 2, wherein the signal traces comprise a plurality of scan lines and a plurality of data lines interlaced with each other, and a width of the at least one reflective structure is greater than or equal to a width of the data line or the scan line.

4. The display panel of claim 2, further comprising a second substrate disposed opposite to the first substrate, wherein the second substrate comprises a black matrix, and a width of the at least one reflective structure is less than or equal to a width of the black matrix.

5. The display panel of claim 2, wherein the first substrate comprises an upper surface and a lower surface opposite to the upper surface, the at least one reflective structure is disposed on the upper surface of the first substrate, and the upper surface is away from a backlight.

6. The display panel of claim 2, wherein the first substrate comprises an upper surface and a lower surface opposite to the upper surface, the at least one reflective structure is disposed on the lower surface of the first substrate, and the lower surface is configured to face a backlight.

7. The display panel of claim 2, further comprising a driving chip, wherein the control circuit is integrated within the driving chip.

8. The display panel of claim 2, further comprising a flexible circuit board and an external driving module, wherein the control circuit is connected to the external driving module, and the flexible circuit board is connected to the first substrate.

9. The display panel of claim 2, wherein the electrochromic layer is configured to have different transmittance according to different voltages applied on the electrochromic layer by the control circuit.

10. The display panel of claim 2, wherein the reflective layer is configured to have different reflectivity according to different voltages applied on the reflective layer by the control circuit.

11. A display device, comprising a display panel and a backlight disposed under the display panel, wherein the display panel comprises:
a first substrate;
at least one reflective structure disposed on the first substrate, wherein the reflective structure comprises a reflective layer and an electrochromic layer disposed on the reflective layer;
signal traces disposed on the first substrate, wherein an orthogonal projection of the at least one reflective structure on the first substrate overlaps at least part of an orthogonal projection of the signal traces on the first substrate; and
a control circuit disposed on the first substrate, and connected to the electrochromic layer.

12. The display device of claim 11, wherein the signal traces comprise a plurality of scan lines and a plurality of data lines interlaced with each other, and a width of the at least one reflective structure is greater than or equal to a width of the data line or the scan line.

13. The display device of claim 11, further comprising a second substrate disposed opposite to the first substrate, wherein the second substrate comprises a black matrix, and a width of the at least one reflective structure is less than or equal to a width of the black matrix.

14. The display device of claim 11, wherein the first substrate comprises an upper surface and a lower surface opposite to the upper surface, the at least one reflective structure is disposed on the upper surface of the first substrate, and the upper surface is away from a backlight.

15. The display device of claim 11, wherein the first substrate comprises an upper surface and a lower surface opposite to the upper surface, the at least one reflective structure is disposed on the lower surface of the first substrate, and the lower surface is configured to face a backlight.

16. The display device of claim 11, further comprising a driving chip, wherein the control circuit is integrated within the driving chip.

17. The display device of claim 11, further comprising a flexible circuit board and an external driving module, wherein the control circuit is connected to the external driving module, and the flexible circuit board is connected to the first substrate.

18. The display device of claim 11, wherein the electrochromic layer is configured to have different transmittance according to different voltages applied on the electrochromic layer by the control circuit.

19. The display device of claim 11, wherein the reflective layer is configured to have different reflectivity according to different voltages applied on the reflective layer by the control circuit.
